(19) United States
(12) Patent Application Publication
(10) Pub. No.: US 2026/0264860 A1
(43) Pub. Date: Sep. 10, 2026

(54) TILTING TABLE AND CONSOLE ASSEMBLY INCLUDING THE SAME

(71) Applicant: KOMOS CO., LTD., Hwaseong-si Gyeonggi-do (KR)

(72) Inventors: Hyeon Muk KIM, Seoul (KR); Dong Min KIM, Anyang-si Gyeonggi-do (KR); In Chul YOO, Hwaseong-si Gyeonggi-do (KR)

(73) Assignee: KOMOS CO., LTD., Hwaseong-si Gyeonggi-do (KR)

(21) Appl. No.: 19/536,439

(22) Filed: Feb. 11, 2026

(30) Foreign Application Priority Data
Mar. 6, 2025 (KR) 10-2025-0029154

(51) Int. Cl. B64D 11/06; B60N 2/75

(52) U.S. Cl. CPC B64D 11/0605; B60N 2/79

(57) ABSTRACT

Provided are a titling table and a console assembly including the tilting table. The tiltable table includes a table housing, a tray exposed to an upper portion of the table housing and provided to be tiltable with respect to the table housing, and a link unit guiding tilting of the tray by connecting a lower surface of the tray with an inner bottom surface of the table housing.

### CROSS-REFERENCE TO RELATED APPLICATION

This application claims priority to Korean Patent Application No. 10-2025-0029154 filed on Mar. 6, 2025, the entire content of which is incorporated by reference.

### BACKGROUND

### 1. Field

The disclosure relates to a titling table and a console assembly including the tilting table. More particularly, the disclosure relates to a tiltable table provided on a moving object such as a vehicle to allow a user to place and view a tablet PC or book at a comfortable viewing angle, and a console assembly including the tilting table.

### 2. Description of the Related Art

Console assemblies of moving objects such as vehicles are provided between driver's seats and passenger seats of vehicles and include storage bins storing items, and armrests that serve as covers and allow passengers to comfortably rest their arms are provided on the storage bins.

Recently, with the emergence of electric vehicles and autonomous vehicles, additional facilities for use convenience of passengers have been required. Accordingly, there is a demand for a table that may place items in a storage space such as a console assembly while being rotatable to a position that is comfortable for a user to view or tiltable at a predetermined angle.

The information disclosed in the background section of the disclosure is intended merely to aid in understanding the overall background of the disclosure and should not be construed as acknowledging or implying in any form that such information constitutes the related art known to one of ordinary skill in the art.

### SUMMARY

Provided is a console assembly including a table that is horizontally rotatable to be closer to a passenger seat.

Provided is also a console assembly in which a table is displaceable to allow use of other items on a console body by minimizing the exposed area when not in use.

Provided are also a table assembly in which a table is tiltable to allow a passenger to place and view a tablet PC or book owned by the passenger at a comfortable viewing angle, and a console assembly including the table assembly.

Provided are also a table assembly in which a table is tiltable in both directions so as to be comfortably viewed from a driver's seat or a front passenger seat, and a console assembly including the table assembly.

Provided are also a table assembly including a tray support so as to prevent items placed on a table from falling down when the table is tilted, and a console assembly including the table assembly.

The solutions of the disclosure are not limited to the above-mentioned contents, and other technical problems not mentioned will be clearly understood by one of ordinary skill in the art from the following description.

According to an embodiment of the disclosure, a console assembly provided on a moving object includes a console body provided on the moving object and storing items, and a table assembly provided on the console body, the table assembly includes a table provided on an upper portion of the console body, a rail unit guiding a linear movement of the table with respect to the console body, and a rotation unit allowing the table to be rotatable on the rail unit at a predetermined position, and the table moves linearly along the rail unit and then is rotatable with respect to the upper portion of the console body at the predetermined position.

The rail unit may include a first rail fixed to the console body, and a second rail that is movable in a horizontal direction relative to the first rail and has an upper portion connected to the table.

The rotation unit may include a sliding plate moving together with the second rail, and a rotating plate rotating on the sliding plate and connected to a lower portion of the table.

A protrusion portion may be provided on a lower portion of the rotating plate, an arc-shaped rotation guide portion that is cut at a predetermined angle may be provided in the sliding plate, and the protrusion portion of the rotating plate may be inserted into the rotation guide portion and guided along the rotation guide portion, such that the rotating plate is rotated with respect to the sliding plate only at a predetermined angle.

A first cutting portion having a cut shape may be provided in an upper surface of the console body such that an upper portion of the rotating plate is inserted and guided, and a rotation prevention shape portion may be provided in the upper portion of the rotating plate so as to prevent the rotating plate from rotating and enable the rotating plate to only linearly move within the first cutting portion.

A second cutting portion may be provided in the upper surface of the console body, be connected to the first cutting portion, and may enable rotation of the rotation prevention shape portion of the rotating plate.

A plurality of bearings may be provided on a lower surface of the rotating plate to reduce a frictional force when the rotating plate rotates around the sliding plate.

The console assembly may further include a locking unit locking a rotation of the rotating plate at a predetermined rotation position on the sliding plate, and the locking unit may include locking holes provided at one or more predetermined angles on the sliding plate, a locking ring rotatably provided under the table and movable in a forward-and-backward direction in the locking holes, a cable having one end connected to the locking ring, and a locking lever provided at other end of the cable and provided to be exposed to outside of the table, and when a user rotates the locking lever, the cable may be pulled to separate the locking ring inserted into the locking hole from the locking hole, and the rotating plate may be unlocked with respect to the sliding plate.

A rotating spring may be provided in the locking ring to provide an elastic force so as to rotate the locking ring in a direction toward the locking hole.

A tiltable tray may be provided on an upper portion of the table.

According to another embodiment of the disclosure, a tiltable table includes a table housing, a tray exposed to an upper portion of the table housing and provided to be tiltable with respect to the table housing, and a link unit guiding tilting of the tray by connecting a lower surface of the tray with an inner bottom surface of the table housing.

The link unit may include a link guide groove provided in the lower surface of the tray and extending in a horizontal direction, and a tilting link having one end moving horizontally along the link guide groove and other end rotatably connected to the table housing.

A torsion spring for elastically pressing the tilting link may be provided on the tilting link to rotate the tray in a tilting direction, and a rubber damper may be provided around an inner circumference of the link guide groove.

The tiltable table may further include a locking unit for locking and unlocking a tilting operation of the tray, and the locking unit may include a locking switch provided on an upper portion of the tray, a locking bar having one end in contact with the locking switch and moving horizontally in conjunction with an up-and-down movement of the locking switch, a locking key provided at the other end of the locking bar, and a locking hole provided in the table housing, through which the locking key moves in a forward-and-backward direction according to a horizontal movement of the locking bar.

A first inclined portion may be provided in a lower portion of the locking switch, and a second inclined portion may be provided at one end of the locking bar, the second inclined portion having a shape corresponding to the first inclined portion, such that the locking bar may move horizontally according to the up-and-down movement of the locking switch.

A tray support may be provided on an opposite side of the tray tilted from the table housing to prevent items placed on the tray from being separated from the tray.

The tray support may not protrude from an upper surface of the tray at a first position where the tray is horizontally placed in the table housing, and may be pushed upward by a lower portion of the table housing to protrude from the upper surface of the tray at a second position where the tray is tilted.

A tray spring for elastically pressing the tray support to the first position may be provided on the tray support.

The link unit may include a first link unit and a second link unit that are provided symmetrically in a pair on the tray to tilt the tray in different directions, the locking unit may include a first locking unit and a second locking unit that are provided symmetrically in a pair on the tray, a locking switch of the first locking unit and a locking switch of the second locking unit may be provided at positions symmetrical to each other on the tray, one or more locking plates may be provided between a pair of locking switches, and when any one of the locking switches is pressed, the locking plates may move to a lower portion of the other locking switch and lock an operation of the other locking switch.

According to another embodiment of the disclosure, a console assembly provided on a moving object includes a console body provided on the moving object and storing items, and a tiltable table provided on an upper portion of the console body and configured to allow adjustment of an angle thereof, and the table includes a table housing, a tray exposed to an upper portion of the table housing and provided to be tiltable with respect to the table housing, and a link unit guiding the tilting of the tray by connecting a lower surface of the tray with an inner bottom surface of the table housing.

The table may be movable in a forward-and-backward direction and rotatable within a predetermined angle range with respect to the console body.

### BRIEF DESCRIPTION OF THE DRAWINGS

FIG. 1 is a perspective view of a table assembly and a console assembly including the table assembly according to an embodiment of the disclosure;

FIG. 2 is a diagram illustrating a table slidably moved forward in the console assembly of FIG. 1;

FIG. 3 is a diagram illustrating a table rotated clockwise in the console assembly of FIG. 1;

FIG. 4 is a diagram illustrating a table rotated counterclockwise in the console assembly of FIG. 1;

FIG. 5 is a diagram illustrating a table rotated and a tray tilted in the console assembly of FIG. 1;

FIG. 6 is an exploded perspective view of a main part of a console assembly according to an embodiment of the disclosure;

FIG. 7 is a cross-sectional view of a rail unit in the console assembly of FIG. 6;

FIG. 8 is an exploded perspective view of a rotation unit in the console assembly of FIG. 6;

FIG. 9 is a diagram for explaining an operation of a rotation unit in the console assembly of FIG. 6;

FIG. 10 is a plan view of a rotation unit in the console assembly of FIG. 6;

FIG. 11 is a cross-sectional view for explaining an operation of a locking unit in the console assembly of FIG. 6;

FIG. 12 is a perspective view for explaining an operation of a locking unit in the console assembly of FIG. 6;

FIG. 13 is a perspective view for explaining an operation of a locking unit in the console assembly of FIG. 6;

FIG. 14 is an exploded perspective view of a tiltable table according to an embodiment of the disclosure;

FIG. 15 is an exploded perspective view of a tray of the table of FIG. 14;

FIG. 16 is a diagram illustrating a lower structure of the tray of the table of FIG. 14;

FIG. 17 is a diagram for explaining a tilting operation of the tray of the table of FIG. 14;

FIG. 18 is a diagram for explaining a tilting operation of the tray of the table of FIG. 14;

FIG. 19 is a diagram for explaining an operation of a locking unit of the table of FIG. 14;

FIG. 20 is a diagram for explaining an operation of a locking unit of the table of FIG. 14;

FIG. 21 is a diagram for explaining a tilting operation order of a tray of the table of FIG. 14; and

FIG. 22 is a diagram for explaining a tray support of FIG. 14.

### DETAILED DESCRIPTION

Hereinafter, embodiments of the disclosure will be described in detail with reference to the accompanying drawings so that one of ordinary skill in the art may easily implement the disclosure. The disclosure may, however, be embodied in many different forms and should not be construed as being limited to the embodiments set forth herein. For clarity, portions that are not relevant to the description of the disclosure are omitted.

The terms used in the specification are merely used to describe particular embodiments of the disclosure, and are not intended to limit the disclosure. An expression used in the singular encompasses the expression of the plural, unless it has a clearly different meaning in the context.

In the specification, it is to be understood that the terms such as "including", "having," and "comprising" are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component

includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the disclosure will be thorough and complete, and will fully convey the concept of the disclosure to one of ordinary skill in the art. In the drawings, sizes and thicknesses of components may be exaggerated for clarity.

Hereinafter, the disclosure will be described in detail with reference to the attached drawings.

### Rotatable Table Assembly

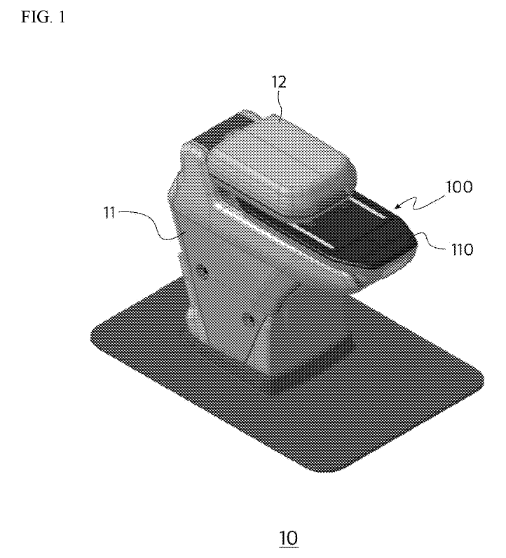

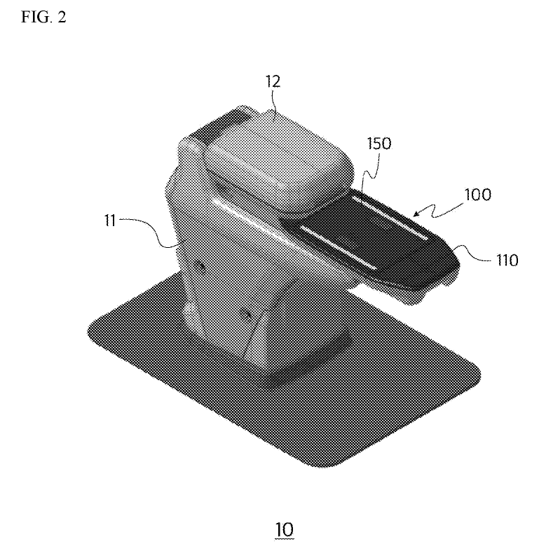

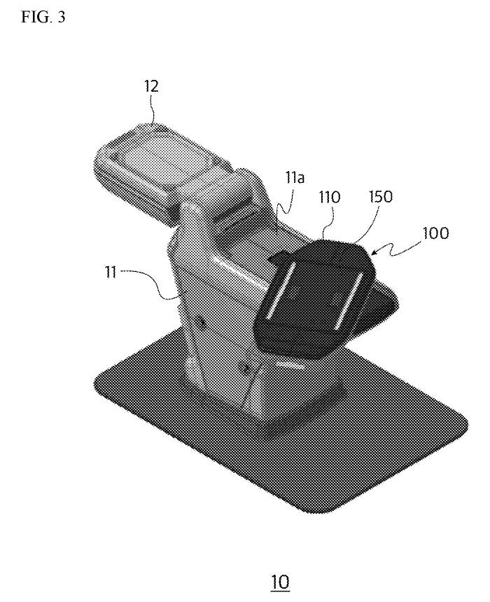

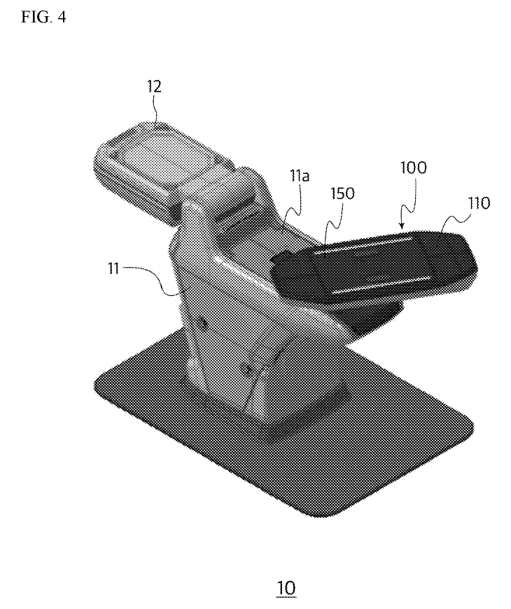

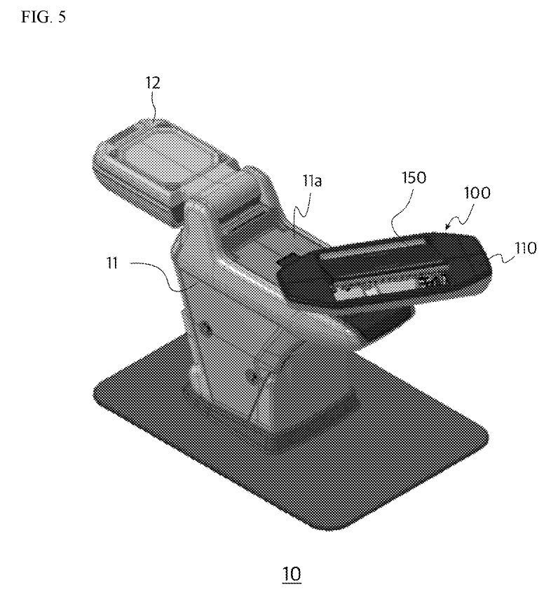

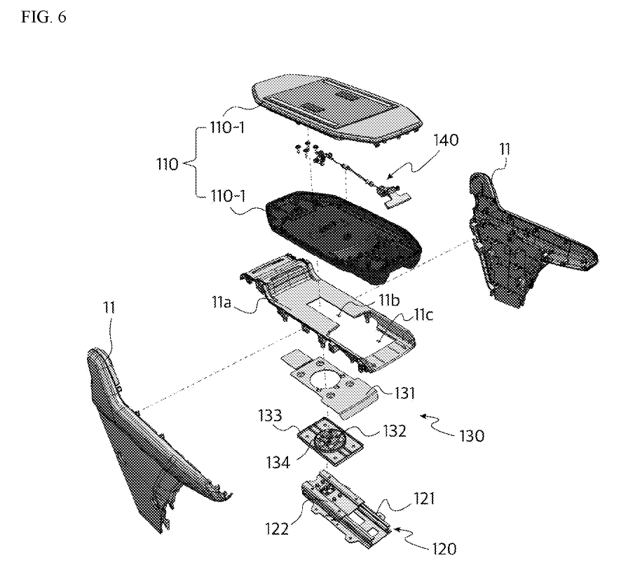

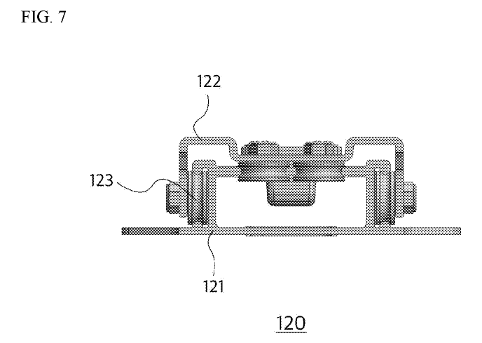

FIG. 1 is a perspective view of a table assembly 100 and a console assembly 10 including the table assembly 100 according to an embodiment of the disclosure. FIG. 2 is a diagram illustrating a table 110 slidably moved forward in the console assembly 10 of FIG. 1. FIG. 3 is a diagram illustrating the table 110 rotated clockwise in the console assembly 10 of FIG. 1. FIG. 4 is a diagram illustrating the table 110 rotated counterclockwise in the console assembly 10 of FIG. 1. FIG. 5 is a diagram illustrating the table 110 rotated and a tray tilted in the console assembly 10 of FIG. 1. FIG. 6 is an exploded perspective view of a main part of the console assembly 10 according to an embodiment of the disclosure; FIG. 7 is a cross-sectional view of a rail unit 120 in the console assembly 10 of FIG. 6.

Referring to FIGS. 1 to 7, the console assembly 10 according to an embodiment of the disclosure is provided on, for example, a moving object such as a car or an airplane and provided for use convenience by passengers. The console assembly 10 includes a console body 11 and the table assembly 100.

The console body 11 may be provided, for example, between a driver's seat and a front passenger seat in a moving object to store passenger’s items, and an armrest 12 where passenger’s arms are rested may be provided thereon.

The table assembly 100 is provided on an upper portion 11a of the console body 11 to provide the table 110 that is slidably movable in a forward-and-backward direction and rotates in a horizontal direction. The table assembly 100 may include the table 110, the rail unit 120, and a rotation unit 130.

The table 110 may have a wide plate shape, be stored with a part placed under the armrest 12, and slidably move forward when in use to increase the exposed area. Because the table 110 is provided on the upper portion 11a of the console body 11, left and right passengers may use the table 110 together. In addition, the table 110 that is stored may be rotated on a horizontal pane, that is, clockwise or counterclockwise, with respect to the upper portion 11a of the console body 11 while being moved forward by a predetermined position. That is, the table 110 may be rotated on the horizontal plane toward a passenger who desires to use a driver's seat on one side or a passenger seat on the other side.

The rail unit 120 is provided to allow the table 110 that is slidable to guide a linear movement in a forward and backward direction with respect to the console body 11. In addition, the rotation unit 130 is provided to allow the table 110 to be rotatable clockwise or counterclockwise on the horizontal plane on the rail unit 120 at a predetermined position.

The rail unit 120 may include a first rail 121 and a second rail 122. The second rail 122 may be fixed within the console body 11, be linearly movable relative to the first rail 121, and have an upper portion connected to the table 110. In addition, a plurality of rail rollers 123 may be provided between the first rail 121 and the second rail 122 to facilitate the relative linear movement of the first rail 121 with respect to the second rail 122. That is, while the second rail 122 slides in a forward-and-backward direction along the first rail 121 fixed to the console body 11, the table 110 connected to the first rail 121 may also be moved in the forward-and-backward direction.

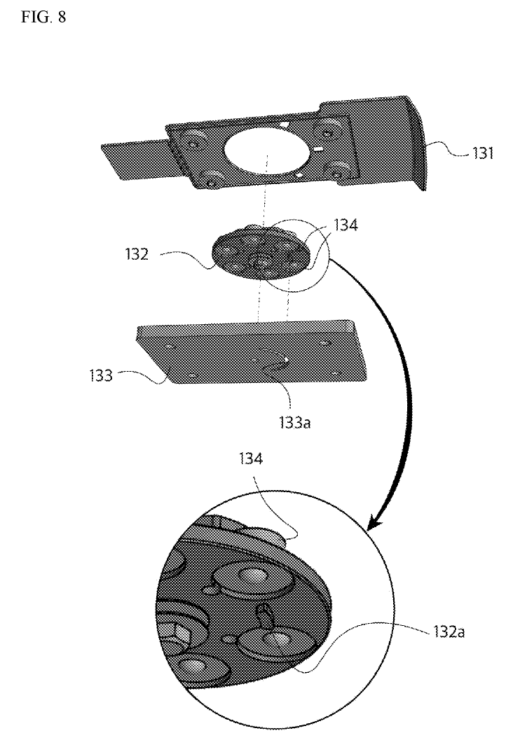

FIG. 8 is an exploded perspective view of the rotation unit 130 in the console assembly 10 of FIG. 6.

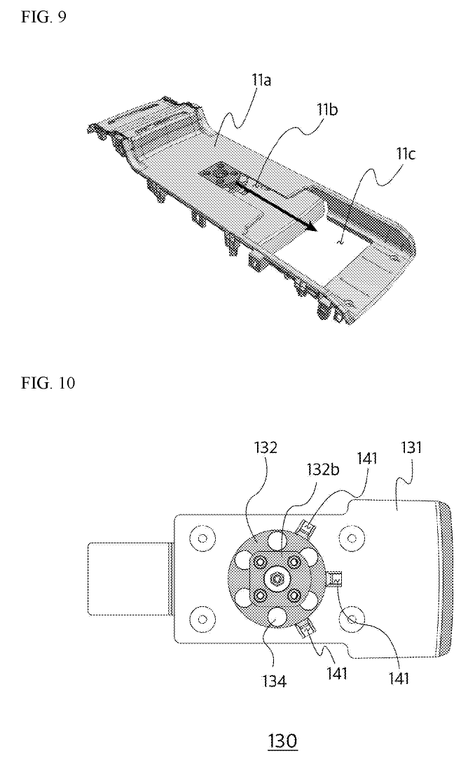

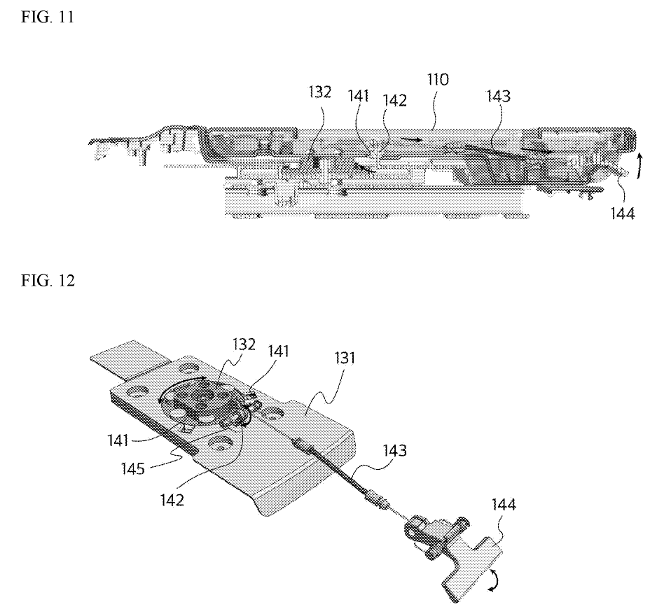

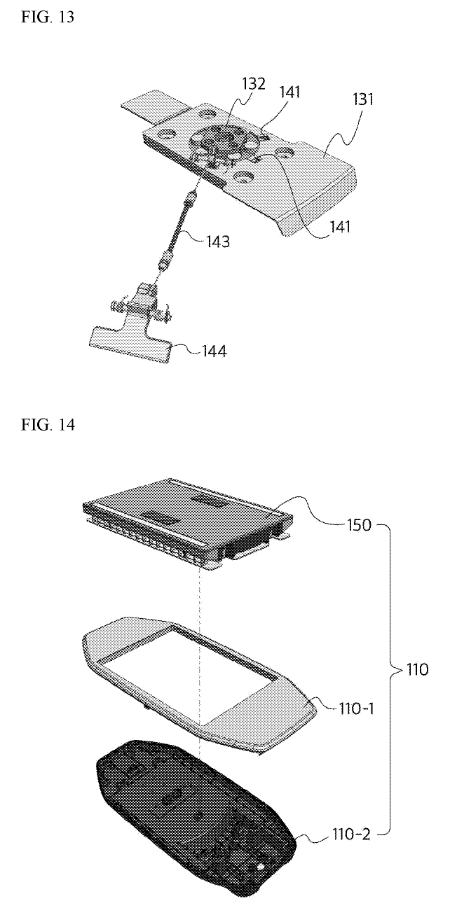

FIG. 9 is a diagram for explaining an operation of the rotation unit 130 in the console assembly 10 of FIG. 6. FIG. 10 is a plan view of the rotation unit 130 in the console assembly 10 of FIG. 6. FIG. 11 is a cross-sectional view for explaining an operation of a locking unit 140 in the console assembly 10 of FIG. 6. FIG. 12 is a perspective view for explaining an operation of the locking unit 140 in the console assembly 10 of FIG. 6. FIG. 13 is a perspective view for explaining an operation of the locking unit 140 in the console assembly 10 of FIG. 6.

Hereinafter, the rotation unit 130 and the locking unit 140 according to an embodiment of the disclosure will be described with reference to FIGS. 9 to 13.

The rotation unit 130 may include sliding plates 131 and 133 and a rotating plate 132. The sliding plates 131 and 133 may include a first sliding plate 131 and a second sliding plate 133 divided into an upper portion and a lower portion. The first sliding plate 131 and the second sliding plate 133 may be fixed on the second rail 122 to move linearly together with the second rail 122 in a forward-and-backward direction with respect to the first rail 121. The rotating plate 132 may rotate clockwise or counterclockwise on the first sliding plate 131 and the second sliding plate 133, but may be connected to a lower portion of the table 110. As a result, when the first sliding plate 131 and the second sliding plate 133 move in the forward-and-backward direction, the table 110 may be linearly movable in the forward-and-backward direction in the same manner, and rotate on the horizontal plane, that is, clockwise or counterclockwise, on the first sliding plate 131 and the second sliding plate 133.

A protrusion portion 132a protruding downward may be provided on a lower portion of the rotating plate 132. In addition, an arc-shaped rotation guide portion 133a that is cut at a predetermined angle may be provided in the first sliding plate 131 and the second sliding plate 133. Because the protrusion portion 132a of the rotating plate 132 is inserted into the rotation guide portion 133a and guided and moved along the rotation guide portion 133a, the rotating plate 132 may be rotated with respect to the first sliding plate 131 and the second sliding plate 133 only at a predetermined angle. In addition, a plurality of ball bearings 134 may be provided on a lower surface of the rotating plate 132 so as to reduce a frictional force generated between the rotating plate 132 and the first sliding plate 131 and the second sliding plate 133 when the rotating plate 132 rotates around the first sliding plate 131 and the second sliding plate 133. As shown, the plurality of ball bearings 134 may be provided with respect to a rotation axis. Thanks to the plurality of ball bearings 134, the contact area between the rotating plate 132 and the second sliding plate 133 is significantly reduced, and accordingly, the frictional force is reduced, and the rotating plate 132 may be rotated smoothly.

In order to prevent the table 110 from rotating in a first state (a state with the minimum exposed area) stored under the armrest 12, and to enable the table 110 to rotate after protruding forward by a predetermined distance, a first cutting portion 11b and a second cutting portion 11c may be provided in the upper portion 11a of the console body 11. Here, the rail unit 120 may be provided under the upper portion 11a of the console body 11. That is, the upper portion 11a of the console body 11 is a cover that finishes a top part of the console body 11, and may include the first cutting portion 11b and the second cutting portion 11c that are cut by a predetermined size to enable linear and rotational movements of the table 110. The first cutting portion 11b is provided to guide a linear movement of the rotating plate 132 with an upper portion of the rotating plate 132 inserted therein. In addition, a rotation prevention shape portion 132b may be provided in the upper portion of the rotating plate 132 so as to prevent the rotating plate 132 from rotating and enable the rotating plate 132 to only linearly move within the first cutting portion 11b. The rotation prevention shape portion 132b has linear parts on opposite sides thereof, and has a width corresponding to the width of the first cutting portion 11b. Due to this shape, when the rotation prevention shape portion 132b is located within the first cutting portion 11b, the rotating plate 132 may not rotate with respect to the first sliding plate 131 and the second sliding plate 133.

The second cutting portion 11c may be connected to the first cutting portion 11b such that an upper portion of the rotating plate 132 may be rotated, but may have a size such that the rotation prevention shape portion 132b of the rotating plate 132 may freely rotate. That is, the width of the second cutting portion 11c may be greater than the width of the first cutting portion 11b such that the rotation prevention shape portion 132b of the rotating plate 132 may rotate. Because the table 110, the rotating plate 132, the second rail 122, and the first rail 121 are coupled to each other in order, the table 110 may move linearly together with the second rail 122 on the first rail 121. That is, the table 110 may linearly move forward at a position where the table 110 is stored under the armrest 12. In this process, the rotation prevention shape portion 132b of the rotating plate 132 may be guided by the first cutting portion 11b of the upper portion 11a of the console body 11 and move only linearly. Thereafter, when the table 110 moves to a predetermined position, that is, when the table 110 moves forward such that the exposed area of the table 110 has a predetermined size, the rotation prevention shape portion 132b of the rotating plate 132 comes to the second cutting portion 11c of the upper portion 11a of the console body 11, and thus, the table 110 may rotate clockwise and counterclockwise on the horizontal plane.

The console assembly 10 according to an embodiment of the disclosure may further include the locking unit 140 that locks a rotation at a predetermined position when the rotating plate 132 rotates on the first sliding plate 131 and the second sliding plate 133. That is, the locking unit 140 may prevent the rotation of the table 110 at a specific angle such that the user may use the table 110 more comfortably and stably.

The locking unit 140 according to an embodiment of the disclosure may include locking holes 141, a locking ring 142, a connection cable 143, and a locking lever 144. The locking holes 141 may be provided at one or more predetermined angles on the first sliding plate 131. In the embodiment, a total of three locking holes 141 may be provided at 0 ° and 60 ° on the left and right with respect to a linear movement direction. The locking ring 142 may be rotatably provided under the table 110 and be movable in a forward-and-backward direction with respect to the locking holes 141 while rotating. The connection cable 143 is for pulling or pushing the locking ring 142, and may have one end connected to the locking hole 141 and the other end connected to the locking lever 144. The locking ever 144 is exposed to the outside of the table 110 such that the user may easily operate the locking lever 144. In an embodiment, the locking lever 144 may be provided below the upper portion of the table 110. The user may pull or push the connection cable 143 by lifting or lowering the locking lever 144. That is, when the user rotates the locking lever 144 upward, the connection cable 143 may be pulled thanks to a link shape of the locking lever 144, and accordingly, the locking ring 142 inserted into the locking hole 141 may be disengaged from the locking hole 141. When the locking ring 142 is disengaged from the locking hole 141, the rotating plate 132 may be unlocked with respect to the first sliding plate 131 and the second sliding plate 133, and thus, the user may rotate the table 110. The rotating spring 145 may be provided in the locking ring 142 to provide an elastic force so as to rotate the locking ring 142 in a direction toward the locking hole 141. Due to this, when the user does not lift the locking lever 144, the locking ring 142 may always rotate downward in the direction toward the locking hole 141, and the connection cable 143 may be pulled toward the locking ring 142, and thus, the locking lever 144 may always be positioned in a downward-facing direction.

The console assembly according to the above-described embodiment may rotate a table horizontally closer to a passenger seat.

In addition, the table is displaceable to allow use of other items on a console body by minimizing the exposed area when not in use.

### Tiltable table

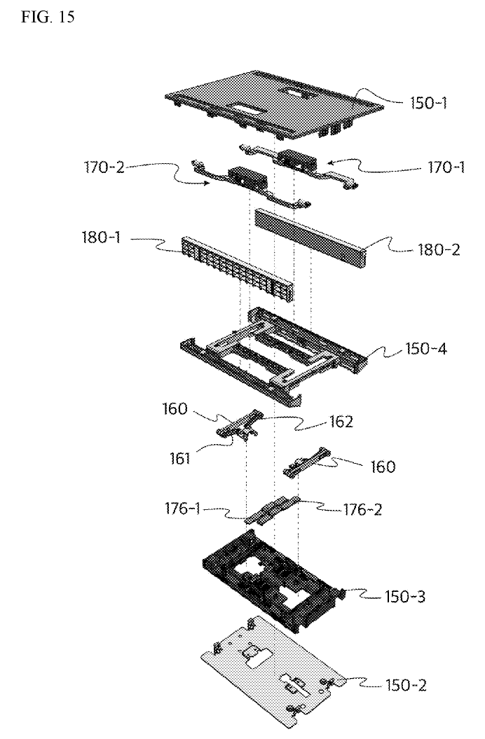

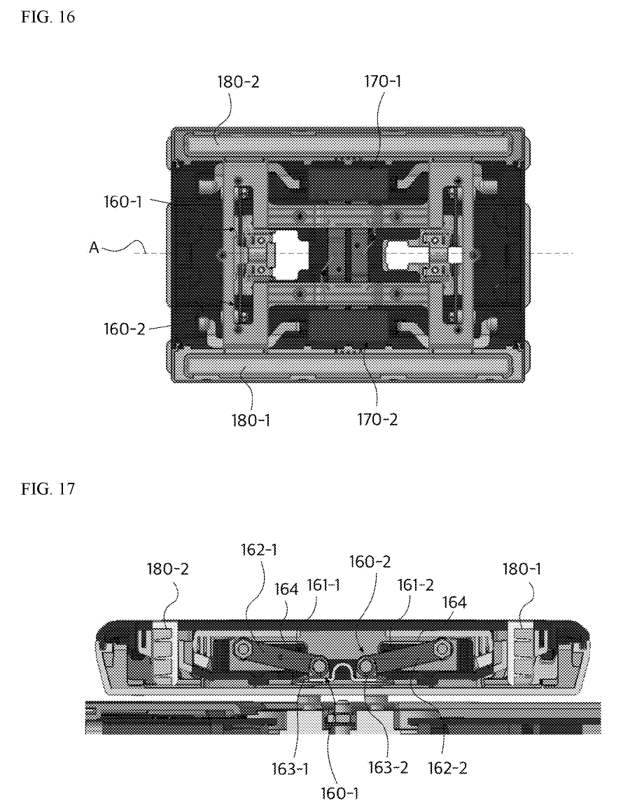

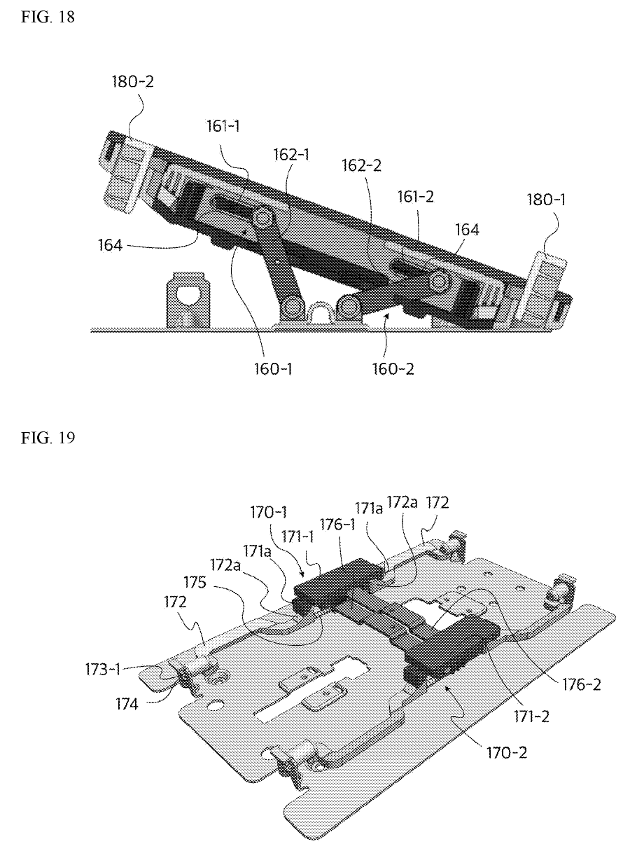

FIG. 14 is an exploded perspective view of the tiltable table 110 according to an embodiment of the disclosure. FIG. 15 is an exploded perspective view of a tray 150 of the table 110 of FIG. 14. FIG. 16 is a diagram illustrating a lower structure of the tray 150 of the table 110 of FIG. 14. FIG. 17 is a diagram for explaining a tilting operation of the tray 150 of the table 110 of FIG. 14. FIG. 18 is a diagram for explaining a tilting operation of the tray 150 of the table 110 of FIG. 14.

Referring to FIGS. 1 to 6 and 14 to 18, the tiltable table 110 according to an embodiment of the disclosure may be provided and used, for example, on the console assembly 10 that is provided on a moving object such as a car or an airplane and is provided for use convenience by passengers. The console assembly 10 may include the console body 11 and the tiltable table 110.

The console body 11 may be provided, for example, between a driver's seat and a front passenger seat to store passenger’s items, and the armrest 12 where passenger’s arms are rested may be provided thereon.

The table 110 may be provided on an upper portion of the console body 11 to allow the adjustment of an angle of the tray 150 thereof. The table 110 may include table housings 110-1 and 110-2, the tray 150, and link units 160 (160-1 and 160-2). The table housings 110-1 and 110-2 form the exterior of the table 110 and accommodate the link unit 160 therein, and have upper surfaces serving as the table 110. The table housings 110-1 and 110-2 may be integrally formed, and the upper housing 110-1 and the lower housing 110-2 may be coupled to each other as shown. The tray 150 may be exposed to upper portions of the table housings 110-1 and 110-2, and may be provided to be tiltable with respect to the upper housing 110-1 and the lower housing 110-2. For example, the tray 150 has a rectangular shape, and may occupy a significant area of upper surfaces of the upper housing 110-1 and the lower housing 110-2. In an embodiment, the tray 150 may be tilted clockwise or counterclockwise along a central axis A of the upper housing 110-1 and the lower housing 110-2 in a longitudinal direction.

The tray 150 may include an upper portion 150-1 on which items may be placed, a lower portion 150-2 fixedly coupled to the table housing 110-2, and frames 150-3 and 150-4 for supporting and installing components such as the link units 160 (160-1 and 160-2), locking units 170 (170-1 and 170-2), and tray supports 180 (180-1 and 180-2) between the upper portion 150-1 and the lower portion 150-2.

The link units 160 may guide the tilting of the tray 150 by connecting a lower surface of the tray 150 with inner bottom surfaces of the upper housing 110-1 and the lower housing 110-2. The link units 160 may be provided in a pair at opposite ends of the tray 150 in a direction perpendicular to the central axis A of the tray 150 in the longitudinal direction. That is, the link units 160 may be provided at opposite ends of the tray 150 in the longitudinal direction such that the tray 150 may be supported to rotate stably at opposite ends of the upper housing 110-1 and the lower housing 110-2. In addition, the link units 160 may be provided as the first link unit 160-1 and the second link unit 160-2, respectively, on the left and right sides of the center axis A of the tray 150 in the longitudinal direction. More specifically, the first link unit 160-1 and the second link unit 160-2 may be provided symmetrically with respect to the central axis A so as to tilt the tray 150 in different directions. Therefore, hereinafter, the link unit 160 will be described in detail with respect to the first link unit 160-1.

The link units 160 may include a pair of tilting links 162-1 and 162-2 having ends moving horizontally along link guide grooves 161-1 and 161-2 and other ends rotatably connected to the table housing 110-2. In an embodiment, the link guide grooves 161-1 and 161-2 may be configured as a pair of shapes symmetrical to each other in a lower portion of the tray 150, that is, the first link guide groove 161-1 and the second link guide groove 161-2. Each of the first link guide groove 161-1 and the second link guide groove 161-2 may extend in a horizontal direction. In addition, the tilting links 162-1 and 162-2 may also be configured in a pair, that is, the first tilting link 162-1 and the second tilting link 162-2, at positions symmetrical to each other. The first link unit 160-1 may include the first link guide groove 161-1 and the first tilting link 162-1, and the second link unit 160-2 may include the second link guide groove 161-2 and the second tilting link 162-2. Ends of the first tilting link 162-1 and the second tilting link 162-2 may be movable horizontally along the first link guide groove 161-1 and the second link guide groove 161-2 extending in the horizontal direction, and other ends of the first tilting link 162-1 and the second tilting link 162-2 may be rotatably connected to the inner bottom surfaces of the upper housing 110-1 and the lower housing 110-2. In addition, torsion springs 163-1 and 163-2 elastically pressing the first tilting link 162-1 and the second tilting link 162-2 may be provided on the first tilting link 162-1 and the second tilting link 162-2 to rotate the tray 150 in a tilting direction. The first torsion spring 163-1 for tilting the tray 150 clockwise may be provided on the first tilting link 162-1, and the second torsion spring 163-2 for tilting the tray 150 counterclockwise may be provided on the second tilting link 162-2. In addition, a damper 164, such as rubber, providing a frictional force may be provided around the inner circumference of each of the first link guide groove 161-1 and the second link guide groove 161-2. As a result, the ends of the first tilting link 162-1 and the second tilting link 162-2 inserted into the first link guide groove 161-1 and the second link guide groove 161-2 are in frictional contact with the damper 164, and thus, the tilting operation of the tray 150 may be performed more smoothly.

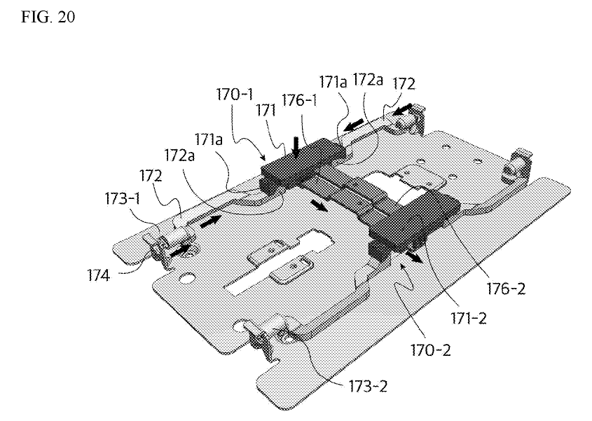

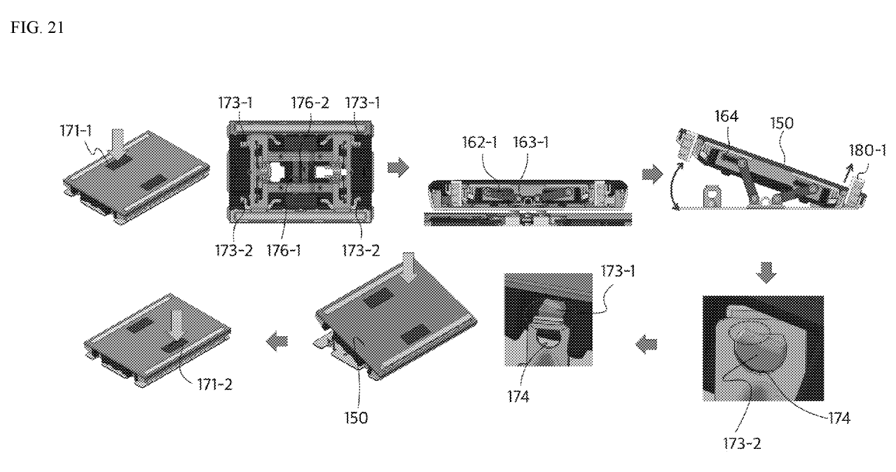

FIG. 19 is a diagram for explaining an operation of the locking unit 170 of the table 110 of FIG. 14. FIG. 20 is a diagram for explaining an operation of the locking unit 170 of the table 110 of FIG. 14. FIG. 21 is a diagram for explaining a tilting operation order of the tray 150 of the table 110 of FIG. 14.

Hereinafter, the locking unit 170 will be described in detail with reference to FIGS. 17 to 21. The tiltable table 110 according to an embodiment of the disclosure may further include the locking unit 170 capable of locking or unlocking a tilting operation of the tray 150.

The locking units 170(170-1 and 170-2) according to an embodiment of the disclosure may include locking switches 171-1 and 171-2, locking bars 172, locking keys 173-1 and 173-2, and locking holes 174. The locking switches 171-1 and 171-2 may be provided one on each of the left and right sides symmetrically with respect to the longitudinal direction of the tray 150. According to an embodiment, one locking switch 171-1 may be provided. In the embodiment, the locking unit 170 may include the first locking unit 170-1 and the second locking unit 170-2, the first locking unit 170-1 may be used to lock or unlock an operation of the first link unit 160-1, and the second locking unit 170-2 may be used to lock or unlock an operation of the second link unit 160-2. Because operations of the first locking unit 170-1 and the second locking unit 170-2 are similar, hereinafter, the first locking unit 170-1 will be mainly described.

The first locking switch 171-1 may be provided to be exposed on an upper portion of the tray 150. The locking bars 172 may be provided symmetrically on opposite sides of the first locking switch 171-1 in the longitudinal direction of the tray 150. One end of the locking bar 172 may be in contact with the first locking switch 171-1 and may be slidably movable. The shapes of one end of the locking bar 172 and one end of the first locking switch 171-1 may be provided as shapes of inclined portions 171a and 172a corresponding to each other. Accordingly, when the first locking switch 171-1 is pressed or raised, the locking bar 172 may move horizontally in conjunction with the up-and-down movement of the first locking switch 171-1. More specifically, the first inclined portions 171a inclined in opposite directions may be provided at opposite sides of a lower surface of the first locking switch 171, and the second inclined portions 172a having shapes corresponding to the first inclined portions 171a may be provided at ends of the pair of locking bars 172. Accordingly, when the first locking switch 171-1 is pressed by a user, the locking bars 172 at opposite sides may be horizontally pulled in a direction toward the first locking switch 171-1. In addition, the locking keys 173 may be respectively provided at the other ends of the pair of locking bars 172. In addition, the locking holes 174 in which the locking keys 173 move in a forward-and-backward direction may be provided in the upper housing 110-1 and the lower housing 110-2 while the tiltable table 110 does not rotate. The locking keys 173 may be inserted into the locking holes 174, thereby locking the tilting of the table 110. When the first locking switch 171-1 is pressed, the pair of locking bars 172 may be pulled according to the downward movement of the first locking switch 171-1, and the locking keys 173 provided at the other ends of the respective locking bars 172 may be disengaged from the locking holes 174.

The pair of locking bars 172 provided at opposite sides with respect to any one of the first locking switch 171-1 and the second locking switch 171-2 may be connected to each other through a compression spring 175. Therefore, when the user presses and releases the first locking switch 171-1 and the second locking switch 171-2, the pair of locking bars 172 move linearly in a horizontal direction away from each other through the compression spring 175, and the first locking switch 171-1 and the second locking switch 171-2 are raised to their original positions according to the linkage between the second inclined portions 172a provided at ends of the locking bars 172 and the first inclined portions 171a of the first locking switch 171-1 and the second locking switch 171-2.

Referring to FIGS. 17 to 21, when the user presses the first locking switch 171-1, the pair of locking bars 172 below the first locking switch 171-1 may be pulled according to the downward movement of the first locking switch 171-1, and the first locking key 173-1 provided at the other end of each locking bar 172 may be disengaged from the locking hole 174. Accordingly, as the first tilting link 162-1 rotates clockwise through the first torsion spring 163-1, the tray 150 is also tilted clockwise. In this regard, because the second locking switch 171-2 is not pressed, the pair of locking bars 172 located in the lower portion of the second locking switch 171-2 are not pulled to each other, and thus, a groove portion of the second locking key 173-2 rotates while being engaged with the inner circumferential surface of the corresponding locking hole 174. Accordingly, the second locking keys 173-2 of the pair of locking bars 174 located in the lower portion of the second locking switch 171-2 may not be disengaged from the corresponding locking hole 174.

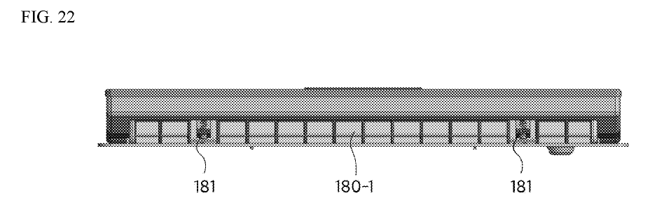

FIG. 22 is a diagram for explaining the tray support 180 of FIG. 14.

Referring to FIGS. 17 to 22, the tray support 180 may be provided on the tray 150 of the tiltable table 110 according to an embodiment of the disclosure. The tray support 180 may be provided on the opposite side of the tilted tray 150 to prevent items placed on the tray 150 from being separated from the tray 150 when the tray 150 is tilted. In the embodiment, the tray supports 180 may also be provided at opposite sides with respect to the tilting center axis A of the tray 150. In other words, when the tray 150 is tilted clockwise, the first tray support 180-1 may be provided on the other side of the first locking switch 171-1 to prevent items from falling down to the right, and when the tray 150 is tilted counterclockwise, the second tray support 180-2 may be provided on the other side of the second locking switch 171-2 to prevent items from falling down to the left.

In an embodiment, each of the first tray support 180-1 and the second tray support 180-2 may not protrude from an upper surface of the tray 150 at a first position where the tray 150 is horizontally placed within the upper housing 110-1 and the lower housing 110-2. In addition, at a second position where the tray 150 is tilted, the first tray support 180-1 and the second tray support 180-2 may be pushed upward by lower portions of the upper housing 110-1 and the lower housing 110-2 to protrude from the upper surface of the tray 150. Tray springs 181 for elastically pressing the first tray support 180-1 and the second tray support 180-2 to the first position may be provided on the first tray support 180-1 and the second tray support 180-2.

In an embodiment, one or more locking plates 176 (176-1 and 176-2) may be provided between the first locking switch 171-1 of the first locking unit 170-1 and the second locking switch 171-2 of the second locking unit 170-2. In the embodiment, the two locking plates 176-1 and 176-2 may be provided. For example, as shown in FIG. 20, when the first locking switch 171-1 is pressed by a user, the first locking plate 176-1 moves to a lower portion of the second locking switch 171-2 by the shape of a plate inclined portion of the first locking switch 171-1. As a result, the second locking switch 171-2 may not be pressed by the user. Similarly, when the second locking switch 171-2 is pressed by the user, the second locking plate 176-2 moves to a lower portion of the first locking switch 171-1 by the shape of a plate inclined portion of the second locking switch 171-2. As a result, the first locking switch 171-1 may not be pressed by the user.

In the console assembly according to the above-described embodiment, a table is tiltable to allow a passenger to place and view a tablet PC or book owned by the passenger at a comfortable viewing angle.

In addition, a table is tiltable in both directions so as to be comfortably viewed from a driver's seat or a front passenger seat, and a tray support may be provided to prevent items placed on the table from falling down when the table is tilted.

The table assembly and the console assembly including the table assembly according to an embodiment of the disclosure may horizontally rotate a table to be closer to a passenger seat.

In addition, the table is displaceable to allow use of other items on a console body by minimizing the exposed area when not in use.

In addition, the table is tiltable such that a passenger may place and view a tablet PC or book owned by the passenger at a comfortable viewing angle.

In addition, the table is tiltable in both directions so as to be comfortably viewed from a driver's seat or a front passenger seat.

In addition, a tray support may be provided so as to prevent items placed on a table from falling down when the table is tilted.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical spirit of the appended claims.

What is claimed is:

1. A tiltable table comprising:
a table housing;
a tray exposed to an upper portion of the table housing and provided to be tiltable with respect to the table housing; and
a link unit guiding tilting of the tray by connecting a lower surface of the tray with an inner bottom surface of the table housing.

2. The tiltable table of claim 1, wherein the link unit comprises:
a link guide groove provided in the lower surface of the tray and extending in a horizontal direction; and
a tilting link having one end moving horizontally along the link guide groove and other end rotatably connected to the table housing.

3. The tiltable table of claim 2, wherein a torsion spring for elastically pressing the tilting link is provided on the tilting link to rotate the tray in a tilting direction, and a rubber damper is provided around an inner circumference of the link guide groove.

4. The tiltable table of claim 2, further comprising a locking unit for locking and unlocking a tilting operation of the tray,
wherein the locking unit comprises:
a locking switch provided on an upper portion of the tray;
a locking bar having one end in contact with the locking switch and moving horizontally in conjunction with an up-and-down movement of the locking switch;
a locking key provided at the other end of the locking bar; and
a locking hole provided in the table housing, through which the locking key moves in a forward-and-backward direction according to a horizontal movement of the locking bar.

5. The tiltable table of claim 4, wherein a first inclined portion is provided in a lower portion of the locking switch, and a second inclined portion is provided at one end of the locking bar, the second inclined portion having a shape corresponding to the first inclined portion, such that the locking bar moves horizontally according to the up-and-down movement of the locking switch.

6. The tiltable table of claim 1, wherein a tray support is provided on an opposite side of the tray tilted from the table housing to prevent items placed on the tray from being separated from the tray.

7. The tiltable table of claim 6, wherein the tray support does not protrude from an upper surface of the tray at a first position where the tray is horizontally placed in the table housing, and is pushed upward by a lower portion of the table housing to protrude from the upper surface of the tray at a second position where the tray is tilted.

8. The tiltable table of claim 7, wherein a tray spring for elastically pressing the tray support to the first position is provided on the tray support.

9. The tiltable table of claim 4, wherein the link unit includes a first link unit and a second link unit that are provided symmetrically in a pair on the tray to tilt the tray in different directions,
the locking unit includes a first locking unit and a second locking unit that are provided symmetrically in a pair on the tray, and
a locking switch of the first locking unit and a locking switch of the second locking unit are provided at positions symmetrical to each other on the tray, one or more locking plates are provided between a pair of locking switches, and when any one of the locking switches is pressed, the locking plates move to a lower portion of the other locking switch and lock an operation of the other locking switch.

10. A console assembly provided on a moving object, the console assembly comprising:
a console body provided on the moving object and storing items; and
a tiltable table provided on an upper portion of the console body and configured to allow adjustment of an angle thereof,
wherein the table comprises:
a table housing;
a tray exposed to an upper portion of the table housing and provided to be tiltable with respect to the table housing; and
a link unit guiding the tilting of the tray by connecting a lower surface of the tray with an inner bottom surface of the table housing.

11. The console assembly of claim 10, wherein the table is movable in a forward-and-backward direction and rotatable within a predetermined angle range with respect to the console body.
